(19) United States
(12) Patent Application Publication
(10) Pub. No.: US 2003/0063896 A1
(43) Pub. Date: Apr. 3, 2003

(54) System utility interface for software upgrades and system diagnostics in automotive or portable DVD players

(76) Inventors: Victor Manuel Gonzalez Tovar, Kokomo, IN (US); Craig Randal Aine, Friedrichsdorf (DE)

Correspondence Address: Corporate Patent Counsel, U.S. Philips Corporation, 580 White Plains Road, Tarrytown, NY, 10591, US

(21) Appl. No.: 09/967,385

(22) Filed: Sep. 28, 2001

(51) Int. Cl. H04N 5/91

(52) U.S. Cl. 386/94; 386/125

(57) ABSTRACT

A portable digital versatile disk player includes nonvolatile (flash) memory logically divided into a boot code sector or sectors and a number of application code sectors, with at least the boot code sector protected during normal operation. During power up, the boot code checks for a disk containing a utilities disk identifier within the player drive, and either begins normal operation or employs a bootstrap loader to copy control software upgrades from the disk to the application code portion of the nonvolatile memory.

### TECHNICAL FIELD OF THE INVENTION

The present invention is directed, in general, to control software upgrades within portable devices and, more specifically, to control software upgrades in portable digital versatile disk players by use of a protected bootstrap loader within the player to load the upgrade from a disk.

### BACKGROUND OF THE INVENTION

In addition to their conventional use as peripherals for televisions and within computers, digital versatile disk (DVD) players are now frequently being installed (with dedicated displays) in automobiles and implemented in other stand-alone designs such as a personal portable DVD player. However, DVD standards and functionality continue to evolve and be extended, such that control software (i.e., “firmware”) upgrades within a DVD player are periodically necessary or desirable.

Conventional DVD players connected to television receivers or within computers are typically coupled to a communications network, such as a telephone system, the Internet, and/or satellite, terrestrial or cable broadcast systems. Accordingly, control software upgrades may be downloaded to such DVD player via one or more of the communications networks. By contrast, DVD players installed within automobiles and similar portable DVD players are not generally coupled to a communications network. Software upgrades to such DVD players therefore typically require dealer or manufacturer participation.

There is, therefore, a need in the art for a mechanism enabling “do-it-yourself” control software upgrades to a DVD player by the user, particularly a portable DVD player not coupled to a communications network.

### SUMMARY OF THE INVENTION

To address the above-discussed deficiencies of the prior art, it is a primary object of the present invention to provide, for use in a portable digital versatile disk player, a nonvolatile (flash) memory logically divided into a boot code sector or sectors and a number of application code sectors, with at least the boot code sector protected during normal operation. During power up, the boot code checks for a disk containing a utilities disk identifier within the player drive, and either begins normal operation or employs a bootstrap loader to copy control software upgrades from the disk to the application code portion of the nonvolatile memory.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a portable digital versatile disc and related systems supporting autonomous control software upgrades according to one embodiment of the present invention;

FIG. 2 is a diagram of the logical organization of nonvolatile memory employed in conjunction with autonomous control software upgrades according to one embodiment of the present invention; and

FIG. 3 is a high level flowchart for a process of performing an autonomous control software upgrade according to one embodiment of the present invention.

### DETAILED DESCRIPTION OF THE INVENTION

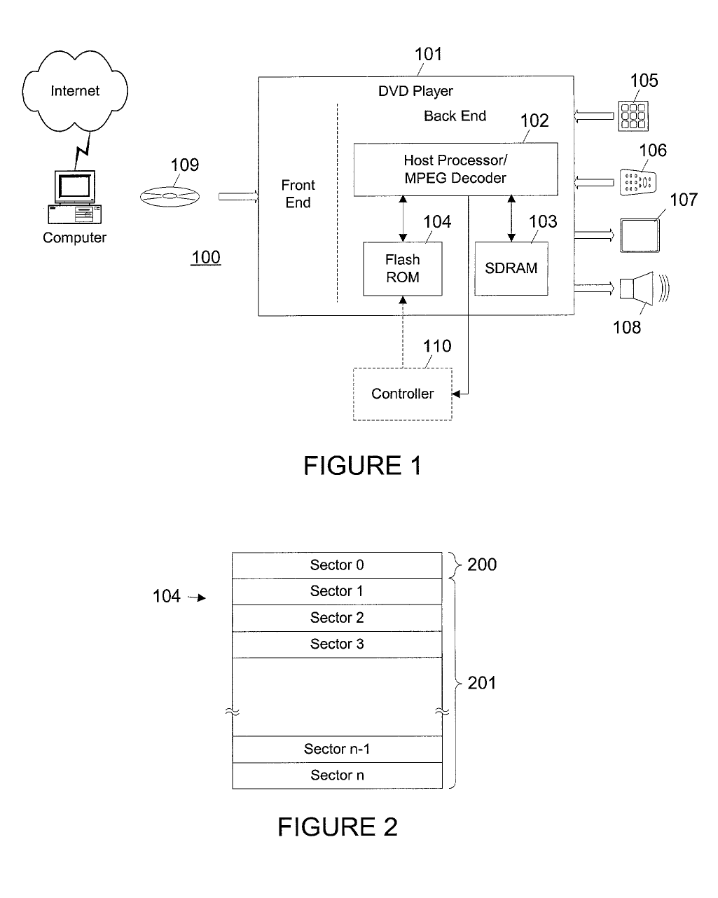

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a portable digital versatile disk and related systems supporting autonomous control software upgrades according to one embodiment of the present invention. Systems 100 include a digital versatile disk player 101 having a front end including optical, drive, and related control systems (not depicted in the diagram) for reading a digital versatile disk and a back end embodying systems for higher level control over the operation of player 101. The back end of player 101 thus includes a host processor 102 with motion picture expert group (MPEG) standard decoder capabilities, a synchronous dynamic random access memory (SDRAM) 103 or similar temporary storage and/or caching device, and a flash read only memory (ROM) 104 or similar nonvolatile storage with both read and write capabilities.

Those skilled in the art will recognize that the entire construction and operation of a digital versatile disk player is not depicted or described herein. Instead, only so much of the construction and operation of a digital versatile disk player as is necessary for an understanding or the present invention or unique to the present invention is depicted and described. In any event, however, the player hardware, software and firmware are designed and implemented to enable autonomous control software upgrades as described herein.

Player 101 may optionally be coupled to one or more input/output (I/O) devices such as a keypad 105, an infrared (IR) remote control 106, a monitor or other video display 107 which may include touchscreen input capabilities, and an audio speaker 108. These devices may be utilized during ordinary operation of player 101, and in some instances during control software upgrades to player 101 to select options within the upgrade process in the event that user interaction is required.

The existing control software for player 101 is stored within flash ROM 104. The control software upgrade is provided on a digital versatile disk 109, which may be sent to the owner of player 101 via parcel delivery service (e.g., U.S. mail). Alternatively, if player 101 is a multi-standard player and the user has access to the Internet and a system having a compact disk, recordable (CD-R) drive, a compact disk, read/write (CD-R/W) drive, a digital versatile disk, recordable (DVD-R) drive, or a digital versatile disk random access memory (DVD-RAM) drive, the control software upgrade may be downloaded and “burned”(written) onto disk 109 by the user.

FIG. 2 is a diagram of the logical organization of nonvolatile memory employed in conjunction with autonomous control software upgrades according to one embodiment of the present invention. The player's nonvolatile memory 104 consists of two main blocks: a boot code section 200 and an application code section 201. The application code 201 is software responsible for executing all function of the normal operation of the player (normal playback functions).

The boot code 200 has the capability of booting the player's main operating system and performing one of the following: running the application code from nonvolatile memory 104 for normal operation; or, utilizing a bootstrap loader utility, reading disk 109 and loading the information contained therein into the nonvolatile memory 104 to perform the control software upgrade for the player 101.

The boot code 200 preferably resides in a protected area or sector (or sectors, if necessary) of nonvolatile memory 104, while the application code 201 resides in either protected or unprotected sectors. If all sectors of nonvolatile memory 104 are protected during normal operation of player 101, an optional controller 110 (depicted as external to player 101 in the exemplary embodiment, but may be integrated into player 101) having the required circuitry temporarily unprotects the sectors of nonvolatile memory 104 while the control software upgrade in being loaded into the application code portion 201 of nonvolatile memory 104. The entire nonvolatile memory 104 may have protection temporarily suspended, or all but the boot code section 200 may be temporarily unprotected.

The boot code 200 within player 101 may determine whether to execute the bootstrap loader or begin normal operation based upon an identifier on the disk 109 indicating that the disk 109 is a utility disk containing a control software upgrade. In addition to the control software upgrades to be loaded into the application code section 201 of nonvolatile memory 104, utility disk 109 may also contain system customization and options configuration (e.g., an interface), system test, diagnostics, adjustment and calibration utilities, and other utilities. These utilities may be executable only while player 101 is in a mode for control software upgrades, but not during normal operation.

Autonomous control software upgrades are performed by the user by loading the disk 109 into player 101 during normal operation, and then restarting the player 101 (i.e., briefly turning power off and then back on). The boot code 200 checks for a disk within player 101, and checks any disk present for a unique identifier at a predetermined location on the disk indicating that the disk is a system utility disk. If the identifier is found, the boot code 200 loads the bootstrap loader and copies the control software upgrades (identified by information on disk 109) to the application code sectors 201 of the nonvolatile memory 104. If no identifier is found, the boot code proceeds to load the application code 201 and begin normal operation of the player 101.

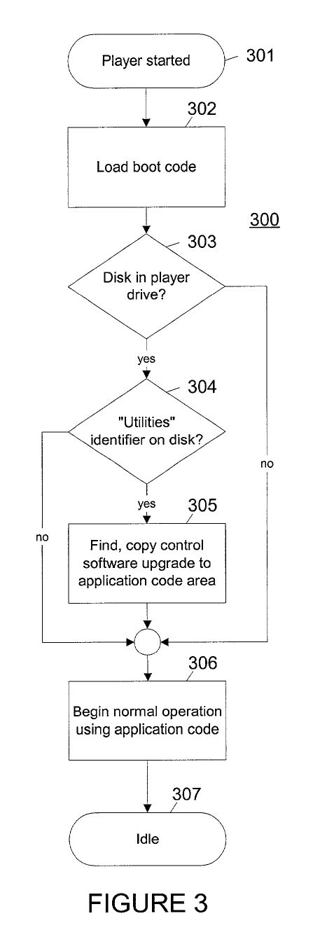

FIG. 3 is a high level flowchart for a process of performing an autonomous control software upgrade according to one embodiment of the present invention. The process 300 begins with a digital versatile disk player being turned on from a previously power-off state (step 301). The boot code is initially loaded (step 302), and the player is checked for the presence of a disk within the player's drive (step 303). If a disk is present within the player's drive, the disk is checked for a “utilities disk” identifier at a predetermined location on the disk (step 304).

If the proper identifier is found, the control software upgrade on the disk is located and copied to the application code portion of the nonvolatile memory (step 305). Normal operation of the player is then begun using the control software within the application code area of the player's nonvolatile memory (step 306), which may be either an existing version of the software or the just-upgrade control software. The process then becomes idle (step 307) until the player is once again turned on from a powered-down state.

The present invention allows a use to upgrade control software within a portable digital versatile disk player, such as a player installed in an automobile, without manufacturer or dealer involvement. The player may thus be kept current with changes and extensions to the digital versatile disk video standard, so that the player need not be replaced. Additional utilities may permit adjustment of the operation of the player (e.g., image alignment to viewable area, etc.).

It is important to note that while the present invention has been described in the context of a fully functional digital versatile disk player, those skilled in the art will appreciate that at least portions of the mechanism of the present invention is capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for upgrading firmware for a portable digital versatile disk player comprising:
a nonvolatile memory logically divided into at least two sections including a boot section and an application section; and
a boot program within the boot section which is loaded when the digital versatile disk player is first turned on, the boot program
checking a disk within the digital versatile disk player for an indication that the disk contains a firmware upgrade, and
responsive to determining that the disk contains a firmware upgrade, copying the firmware upgrade to the application section of the nonvolatile memory.

2. The system as set forth in claim 1 wherein the boot section contains software initially loaded when the digital versatile disk player is first turned on and the application section contains software loaded for normal operation of the digital versatile disk player.

3. The system as set forth in claim 2 wherein the indication that the disk contains a firmware upgrade is a predetermined identifier at a predetermined location on the disk.

4. The system as set forth in claim 2 wherein the boot program checks for a disk within the player and, responsive to finding no disk within the player, initiates normal operation of the digital versatile disk player utilizing software within the application section of the nonvolatile memory.

5. The system as set forth in claim 2 wherein the boot program, after copying the firmware upgrade to the application section of the nonvolatile memory, initiates normal operation of the digital versatile disk player utilizing software within the application section of the nonvolatile memory.

6. The system as set forth in claim 2 wherein the boot section of the nonvolatile memory is always protected, while the application section is always unprotected.

7. The system as set forth in claim 2 wherein the boot section of the nonvolatile memory is always protected, while the application section is protected during normal operation of the digital versatile disk player and wherein the boot code initiates temporary suspension of protection for the application section in response to determining that the disk contains a firmware upgrade.

8. A portable digital versatile disk player comprising:
a display for displaying video content of a digital versatile disk during at least normal operation of the digital versatile disk player;
a processor decoding video content of a digital versatile disk for display on the display;
a nonvolatile memory containing firmware controlling operation of the digital versatile disk player and logically divided into at least two sections including a boot section and an application section; and
a boot program within the boot section which is loaded when the digital versatile disk player is first turned on, the boot program
checking a disk within the digital versatile disk player for an indication that the disk contains a firmware upgrade, and
responsive to determining that the disk contains a firmware upgrade, copying the firmware upgrade to the application section of the nonvolatile memory.

9. The portable digital versatile disk player as set forth in claim 8 wherein the boot section contains software initially loaded when the digital versatile disk player is first turned on and the application section contains software loaded for normal operation of the digital versatile disk player.

10. The portable digital versatile disk player as set forth in claim 9 wherein the indication that the disk contains a firmware upgrade is a predetermined identifier at a predetermined location on the disk.

11. The portable digital versatile disk player as set forth in claim 9 wherein the boot program checks for a disk within the player and, responsive to finding no disk within the player, initiates normal operation of the digital versatile disk player utilizing software within the application section of the nonvolatile memory.

12. The portable digital versatile disk player as set forth in claim 9 wherein the boot program, after copying the firmware upgrade to the application section of the nonvolatile memory, initiates normal operation of the digital versatile disk player utilizing software within the application section of the nonvolatile memory.

13. The portable digital versatile disk player as set forth in claim 9 wherein the boot section of the nonvolatile memory is always protected, while the application section is always unprotected.

14. The portable digital versatile disk player as set forth in claim 9 wherein the boot section of the nonvolatile memory is always protected, while the application section is protected during normal operation of the digital versatile disk player and wherein the boot code initiates temporary suspension of protection for the application section in response to determining that the disk contains a firmware upgrade.

15. A method for upgrading firmware for a portable digital versatile disk player comprising:
employing firmware within a nonvolatile memory to control operation of the digital versatile disk player, the nonvolatile memory logically divided into at least two sections including a boot section and an application section; and
loading a boot program within the boot section when the digital versatile disk player is first turned on;
employing the boot program to check a disk within the digital versatile disk player for an indication that the disk contains a firmware upgrade; and
employing the boot program, in response to determining that the disk contains a firmware upgrade, to copy the firmware upgrade to the application section of the nonvolatile memory.

16. The method as set forth in claim 15 wherein the step of employing firmware within a nonvolatile memory to control operation of the digital versatile disk player further comprises:
initially loading software within the boot section when the digital versatile disk player is first turned on; and
loading software within the application section for normal operation of the digital versatile disk player.

17. The method as set forth in claim 16 wherein the step of employing the boot program to check a disk within the digital versatile disk player for an indication that the disk contains a firmware upgrade further comprises:
employing the boot program to check for a predetermined identifier at a predetermined location on the disk.

18. The method as set forth in claim 16 further comprising:
employing the boot program to check for a disk within the player and, responsive to finding no disk within the player, initiate normal operation of the digital versatile disk player utilizing software within the application section of the nonvolatile memory.

19. The method as set forth in claim 16 further comprising:
after copying the firmware upgrade to the application section of the nonvolatile memory, employing the boot program to initiate normal operation of the digital versatile disk player utilizing software within the application section of the nonvolatile memory.

20. The method as set forth in claim 16 further comprising:
continually maintaining the boot section of the nonvolatile memory in a protected state; and
one of the following:
continually maintaining the application section of the nonvolatile memory in an unprotected state; and
maintaining the application section of the nonvolatile memory in the protected state during normal operation of the digital versatile disk player and employing the boot code to initiate temporary suspension of protection for the application section in response to determining that the disk contains a firmware upgrade.
